(19) United States
(12) Patent Application Publication
(10) Pub. No.: US 2016/0037785 A1
(43) Pub. Date: Feb. 11, 2016

(54) COFFEE CHERRY FOOD PRODUCTS AND METHODS FOR THEIR PREPARATION

(71) Applicant: EMPIRE TECHNOLOGY DEVELOPMENT LLC, Wilmington, DE (US)

(72) Inventors: Daniel Alderic BELLIVEAU, Bellevue, WA (US); Scott Allen James MCMARTIN, Seattle, WA (US)

(21) Appl. No.: 14/774,116

(22) PCT Filed: Dec. 20, 2013
(86) PCT No.: PCT/US2013/077268

§ 371 Date: Sep. 9, 2015

Related U.S. Application Data
(60) Provisional application No. 61/785,195, filed on Mar. 14, 2013.

(51) Int. Cl. A21D 13/06; A23L 1/16; A21D 2/36; A21D 13/00; A21D 10/00; A23L 1/212; A21D 13/04

(52) U.S. Cl. CPC A21D 13/066; A23L 1/2126; A23L 1/16; A21D 13/04; A21D 13/0019; A21D 10/005; A21D 2/36; A23V 2002/00

(57) ABSTRACT

Food products having portions of coffee cherries are described, as well as components thereof and methods of forming. One such food product may include a first ingredient and a second ingredient. The first ingredient may have one or more portions of a dried coffee cherry. The second ingredient may include at least one of a fat, a flour composition, a dairy product, a flavoring agent, a leavening agent, an enzyme, a modified starch, a gum, a reducing sugar, a sweetener, or a salt.

### CROSS-REFERENCE TO RELATED APPLICATIONS

This application claims the priority benefit of U.S. Provisional Patent Application No. 61/785,195, filed Mar. 14, 2013 and entitled “Flour Compositions and Food and Beverages Comprising Thereof”, which is incorporated herein by reference in its entirety.

### BACKGROUND

The domestic consumption of coffee has increased about 57.6% in coffee exporting countries between 2000 and 2011. In addition, the consumption of coffee in coffee importing countries has increased about 10.8% between 2000 and 2010. In total, world coffee production in 2011 used about 7.9 million tons of coffee beans.

To obtain the coffee beverage that is widely consumed throughout the world, coffee beans must be removed from coffee cherries and processed. There are two types of isolation processes (“coffee processing”) that are commonly used: dry processing and wet processing. Dry processing includes, after harvesting, drying the coffee cherries to about 10-11% moisture content. The coffee beans are separated from the material covering the beans (for example, the outer skin, pulp, parchment, and silverskin) using a de-hulling machine. Wet processing, on the other hand, does not require drying of the cherries. In a wet processing method, the outer skin and the pulp are mechanically removed and the beans are fermented to remove a layer of remaining pulp material thereon, which is about 0.5 mm to about 2 mm thick. After fermentation, the coffee beans are dried so they contain about 12% water by weight and dehulled to remove the parchment. The bean is the only material retained for sale or storage, with the remainder of the coffee cherries being discarded, used as organic compost, or burned as fuel. Thus, when the remainder is discarded, 50% of the total mass of the coffee cherry is discarded as byproduct material. Thus, to obtain every ton of coffee beans, a ton of byproduct material must be generated. With the ever-increasing consumption of coffee throughout the world, the amount of byproduct has rapidly increased.

In coffee producing countries, the coffee byproducts constitute a source of contamination and environmental concern. For example, the pulp and the mucilage are relatively acidic, corrosive to equipment, and difficult to safely dispose. Furthermore, the pulp and the mucilage can lower the pH of waterways, which could potentially be deleterious to fish and other aquatic life forms. Additionally, where the pulp is discarded in a landfill or other disposal site, rotting pulp will often generate significant odors over time. Accordingly, it may be desirable to reduce waste from coffee byproducts, particularly portions of the coffee cherry that are not used for typical coffee bean purposes, such as, for example, the pulp, the mucilage, the stem, and/or the hull.

Previous methods of reducing waste included processing the coffee byproducts for human consumption. However, these methods have been unsuccessful due to taste issues such as flavor, texture, and/or the like. These methods have also been unsuccessful due to an inability of the byproducts to mix with other ingredients to form food products, an inability to comply with human and/or other animal consumption safety requirements, and/or the like.

### SUMMARY

In an embodiment, a food product may include a first ingredient and a second ingredient. The first ingredient may have one or more portions of a dried coffee cherry, including at least one of a pulp, a mucilage, and a hull. The dried coffee cherry in some embodiments does not include a coffee bean. The second ingredient may include at least one of a fat, a flour composition, a dairy product, a flavoring agent, a leavening agent, an enzyme, a modified starch, a gum, a reducing sugar, a sweetener, or a salt.

In an embodiment, a substantially gluten-free food product may include a first ingredient and a second ingredient. The first ingredient may include one or more portions of a dried coffee cherry, including at least one of a pulp, a mucilage, and a hull. The dried coffee cherry in some embodiments does not include a coffee bean. The second ingredient may include at least one of a fat, a flour composition, a dairy product, a flavoring agent, a leavening agent, an enzyme, a modified starch, a gum, a reducing sugar, a sweetener, or a salt. The food product may have a gluten content of less than or equal to about 20 parts per million (ppm).

In an embodiment, a solid composition may include at least one portion of a dried coffee cherry. The portion of the dried coffee cherry may include at least one of a pulp, a mucilage, and a hull. The dried coffee cherry in some embodiments does not include a coffee bean. The portion of the dried coffee cherry may also have an average particle size of about 0.1 μm to about 300 μm.

In an embodiment, a method of forming a food product may include providing a particulate composition comprising at least one portion of a dried coffee cherry, admixing a flour composition with the particulate composition to provide a dry composition, and admixing at least one fluid to the dry composition to form a dough. The dried coffee cherry in some embodiments does not include a coffee bean. The dried coffee cherry may include a deseeded coffee cherry.

### BRIEF DESCRIPTION OF THE DRAWINGS

FIG. 1 depicts a cross sectional view of a coffee cherry structure according to an embodiment.

FIG. 2 depicts a second cross sectional view of a coffee cherry structure according to an embodiment.

FIG. 3 depicts a flow diagram of a method of forming a food product according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A “coffee cherry” generally refers to one whole fruit of the coffee tree, belonging to the genus Coffea. A coffee cherry includes various portions, as described herein, including a coffee bean (or “seed”), pulp, mucilage, a hull, a stem, and the like. Species of coffee trees that produce coffee cherries include, without limitation, Coffea arabica and Coffea canephora. Beans from coffee cherries produced by the Coffea arabica tree are generally referred to as “Arabica” beans, while beans from coffee cherries produced by the Coffea canephora are generally referred to as “Robusta” beans.

A “deseeded coffee cherry” is a coffee cherry that has had the bean portion (including the center cut and the endosperm) removed. Thus, a deseeded coffee cherry contains all of the portions of the coffee cherry except for the bean and its constituent parts. Portions of the deseeded coffee cherry will be discussed in greater detail herein, and generally include hull, mucilage, silverskin, a parchment coat, a pectin layer, pulp, outer skin, a stem, leaves, and the like. In some embodiments, the deseeded coffee cherry may only include certain portions of the coffee cherry and may exclude other portions in addition to the coffee bean. For example, in some embodiments, the deseeded coffee cherry may consist of the pulp, the mucilage, and/or the hull. In some embodiments, the deseeded coffee cherry can include the outer skin, pulp, and pectin layer.

A “particulate composition” includes one or more portions of a dried and deseeded coffee cherry, as described herein. The particulate composition may also be referred to herein as a first ingredient. Thus, the terms “particulate composition” and “first ingredient” may be used interchangeably herein. A “solid composition” includes the particulate composition ground to a particular particle size, as described in greater detail herein. A “dry composition” includes the particulate composition and a flour composition, as described in greater detail herein. A “dough” includes the dry composition and a fluid, as described in greater detail herein.

A “food product” is generally any edible item that is fit for consumption by humans and/or animals. The type of food product is not limited by this disclosure, and includes, for example, a baked good, a pre-fabricated good, a fried good, a chilled good, a nutritional supplement, a steamed good, a cracker, a brownie, a cake, a cake-like product, a pastry, a snack, an energy bar, a pasta, a noodle, a batter coating, a batter coated item, a bread, a cookie, a noodle, a filled food product, a flatbread, a dumpling, a steamed bun, a breaded coating, a breaded item, a cereal, and/or the like.

A “substantially gluten-free” or a “gluten-free” food product as described herein generally refers to food products and/or any components thereof that have substantially no gluten or a gluten content containing an amount of gluten acceptable for labeling as being “gluten-free.” A food product that is substantially gluten-free may have a gluten content of less than or equal to about 20 parts per million (ppm), including about 15 ppm, about 10 ppm, about 5 ppm, about 3 ppm, about 1 ppm, about 0.5 ppm, about 0.1 ppm, about 0.05 ppm, 0 ppm, or any value or range between any two of these values (including endpoints). The United States Food and Drug Administration (FDA) recognizes “gluten-free” food products as not having: (1) an ingredient that is any type of wheat, rye, barley, or crossbreeds of these grains; (2) an ingredient derived from these grains that has been processed to remove gluten; and (3) an ingredient derived from these grains that has been processed to remove gluten, if it results in the food product containing 20 ppm or more of gluten. Other countries, such as, for example, New Zealand and Australia, permit “gluten-free” food labeling in food products having less than 3 ppm gluten. Any of the food products, solid compositions, particulate compositions, dry compositions, and doughs described herein will be recognized by those with ordinary skill in the art as optionally being substantially gluten-free.

Components of deseeded coffee cherries possess many potentially beneficial substances if preserved in a non-degraded (non-fermented) state. For example, fresh pulp contains high levels of polyphenol antioxidants, and fresh mucilage contains complex polysaccharides and antioxidants. The hull also contains small amounts of polyphenols and thus could be used as an additional source for antioxidants. Therefore, better utilization of these byproducts of deseeded coffee cherries could make the cultivation and processing of coffee more economical.

The food products disclosed herein are generally directed to a food product that incorporates at least a portion of the coffee cherry that would otherwise be discarded as byproduct material. These portion(s) of the coffee cherry are combined with one or more additional ingredients to produce food products that possess beneficial properties, are generally pleasant tasting, comply with food safety requirements, and/or can be produced for mass consumption.

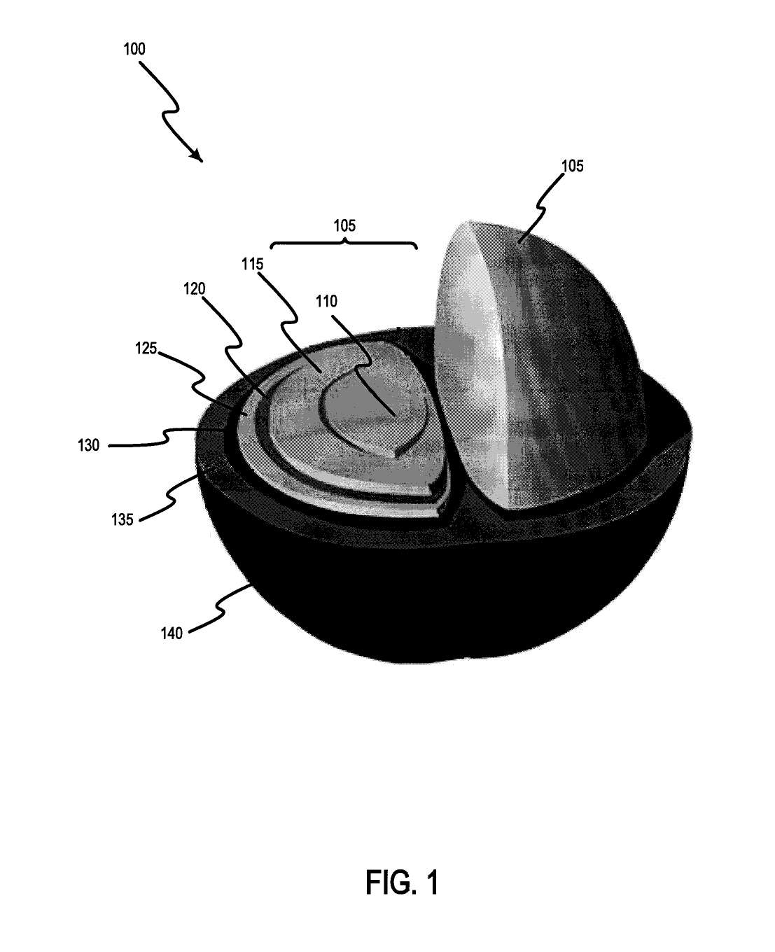

FIG. 1 depicts a cross sectional view of a coffee cherry, generally designated 100, according to an embodiment. The coffee cherry 100 generally includes the bean 105, which is the portion that is usually removed and processed for coffee beverages as described in greater detail herein. The bean 105 may generally include a center cut 110 and an endosperm 115. The center cut 110 is generally the innermost portion of the bean 105, and the endosperm 115 is generally a portion that acts as a food store because it contains a starch, protein, and other nutrients.

The remainder of the coffee cherry 100 may generally be referred to as a deseeded coffee cherry, and may contain, for example, a silverskin 120, a parchment coat 125, a pectin layer 130, a pulp 135, and an outer skin 140. In some embodiments, the deseeded coffee cherry can include the outer skin 140, pulp 135, and pectin layer 130. The silverskin 120 may also be referred to as the epidermis. The silverskin 120 is a thin tegument (covering) that is generally the innermost portion of the coffee cherry 105 that encapsulates the bean 105. The silverskin 120 is a major byproduct of the roasting process to produce roasted coffee beans, and may contain high levels of antioxidants. In general, the silverskin 120 may cling to the bean 105 even after the drying process, and may be removed via polishing or roasting the bean. When the silverskin 120 is removed from the bean 105 during the roasting process, it is typically referred to as chaff. The parchment coat 125, which may also be known as the endocarp or the hull, surrounds the silverskin 120 with a parchment-like covering. Surrounding the parchment coat 125 is the pectin layer 130, which is a mucus-like substance. The pectin layer 130 is surrounded by the pulp 135, which is also known as the mesocarp. The pulp 135 is a fibrous mucilagenous material that is fleshy in appearance and texture. The pulp 135 may include an amount of caffeine and tannins, thus making the pulp somewhat toxic, as described in greater detail herein. The pulp 135 may be processed to remove or reduce the level of toxins, as described in greater detail herein. The outer skin 140 is the outermost portion of the coffee cherry 100, which is generally a thick membrane that protects the various other contents of the coffee cherry. The outer skin 140 may sometimes be referred to as the exocarp. The coffee cherry 100 as used herein may also include other portions not specifically shown in FIG. 1, including a stem, leaves, and/or the like.

In various embodiments, one or more of the portions of the deseeded coffee cherry 100 may be processed to obtain a particulate composition for use as described herein. Processing may include, for example, separating the portions of the deseeded coffee cherry from the coffee bean via a wet processing method or a dry processing method. In some embodiments, the various portions of the deseeded coffee cherry may be dried. In particular embodiments, the deseeded portions of the coffee cherry may be dried so that they contain a moisture content of about 0% by weight to about 20% by weight or about 2% by weight to about 12% by weight, including about 1% by weight, about 2% by weight, about 3% by weight, about 4% by weight, about 5% by weight, about 6% by weight, about 7% by weight, about 8% by weight, about 9% by weight, about 10% by weight, about 11% by weight, about 12% by weight, about 15% by weight, about 20% by weight, or any value or range between any two of these values (including endpoints).

Processing may further include, for example, grading and classifying the portions of the deseeded coffee cherry to remove any portions that may not be usable for the purposes described herein. Examples of grading and classifying may include, for example, removing undesirable portions, inspecting for color, inspecting for clumping, inspecting for moisture level, and inspecting for foreign materials.

Processing may also include grinding, milling and/or pre-milling the portions of the deseeded coffee cherry to obtain the particulate composition. Grinding may be performed by various grinding devices known to those having ordinary skill in the art, such as a hammer mill, a roller mill, a disk mill, or the like. The particulate compositions and/or portions thereof may be ground to various sizes, defined by a particle size (for instance, measured in micrometers), a mesh size, a surface area, or the like. In some embodiments, the particulate composition may have an average particle size of about 0.1 micrometers (μm) to about 5000 μm, about 0.1 μm to about 3000 μm, or about 0.1 μm to about 200 μm. In particular embodiments, the particulate composition may have an average particle size of about 0.1 μm, about 0.5 μm, about 1 μm, about 10 μm, about 25 μm, about 40 μm, about 50 μm, about 100 μm, about 200 μm, about 400 μm, about 500 μm, about 1000 μm, about 2000 μm, about 3000 μm, about 4000 μm, about 5000 μm, or any value or range between any two of these values (including endpoints). In some embodiments, the particulate composition may have a coarse average particle size for shipping and transport. The coarse average particle size may be about 2000 μm to about 5000 μm, including about 2000 μm, about 2500 μm, about 3000 μm, about 4000 μm, about 5000 μm, or any value or range between any two of these values (including endpoints). In some embodiments, the particulate composition may be milled at a final processing destination to produce a fine average particle size. The fine average particle size may be about 1 μm to about 400 μm, including about 1 μm, about 10 μm, about 20 μm, about 25 μm, about 40 μm, about 50 μm, about 75 μm, about 100 μm, about 200 μm, about 300 μm, about 400 μm, or any value or range between any two of these values (including endpoints). In some embodiments, the particulate composition may be ground so that about 10% to about 20% of the ground particulate composition is retained by a mesh having openings with a size of about 20 mesh and so that about 80% to about 90% of the ground particulate composition is retained by a mesh having openings with a size of about 230 mesh. The mesh sizes may be standardized according to Table 1 below:

TABLE 1
MESH TO MICROMETER CONVERSION CHART

| U.S. MESH | INCHES | MICROMETERS |
|---|---|---|
| 3 | 0.2650 | 6730 |
| 4 | 0.1870 | 4760 |
| 5 | 0.1570 | 4000 |
| 6 | 0.1320 | 3360 |
| 7 | 0.1110 | 2830 |
| 8 | 0.0937 | 2380 |
| 10 | 0.0787 | 2000 |
| 12 | 0.0661 | 1680 |
| 14 | 0.0555 | 1410 |
| 16 | 0.0469 | 1190 |
| 18 | 0.0394 | 1000 |
| 20 | 0.0331 | 841 |
| 25 | 0.0280 | 707 |
| 30 | 0.0232 | 595 |
| 35 | 0.0197 | 500 |
| 40 | 0.0165 | 400 |
| 45 | 0.0138 | 354 |
| 50 | 0.0117 | 297 |
| 60 | 0.0098 | 250 |
| 70 | 0.0083 | 210 |
| 80 | 0.0070 | 177 |
| 100 | 0.0059 | 149 |
| 120 | 0.0049 | 125 |
| 140 | 0.0041 | 105 |
| 170 | 0.0035 | 88 |
| 200 | 0.0029 | 74 |
| 230 | 0.0024 | 63 |
| 270 | 0.0021 | 53 |
| 325 | 0.0017 | 44 |
| 400 | 0.0015 | 37 |

Thus, the particulate composition may be ground to a particulate size that ranges from about 20 mesh to about 230 mesh, including about 20 mesh, about 25 mesh, about 30 mesh, about 35 mesh, about 40 mesh, about 45 mesh, about 50 mesh, about 60 mesh, about 70 mesh, about 80 mesh, about 100 mesh, about 120 mesh, about 140 mesh, about 170 mesh, about 200 mesh, about 230 mesh, or any value or range between two of these values (including endpoints). In some embodiments, the particulate compositions and/or various portions thereof may have a varying distribution of particle sizes based upon the ingredients. Thus, the varying mesh sizes of each ingredient may be independent of mesh sizes for other ingredients.

The coffee cherry and/or various portions thereof may naturally contain one or more toxins, including mycotoxins such as aflatoxins, fumonisins, ochratoxins, vomitoxins, and/or the like. Accordingly, processing may include reducing or removing toxins from the portions of the deseeded coffee cherry. Alternatively, processing may include removing or reducing toxins from the particulate composition. The reducing or removing of toxins may improve consumers' safety and/or enable compliance with various safety regulations such as, for example, the World Health Organization's (WHO) International Programme on Chemical Safety (IPCS) or the Scientific Committee on Food (SCF) of the European Union (EU). Thus, in some embodiments, the portions of the deseeded coffee cherry and/or the particulate composition may have an aflatoxin mycotoxin level that is less than or equal to about 20 parts per billion (ppb) for total aflatoxins, a fumonisin mycotoxin level that is less than or equal to about 2 micrograms (μg) per kilogram of body weight of a consumer for total fumonisins, an ochratoxin mycotoxin level of less than or equal to about 10 ppb for total ochratoxins, and/or a vomitoxin mycotoxin level of less than or equal to about 1 part per million (ppm) for vomitoxins. In particular embodiments, the portions of the deseeded coffee cherry and/or the particulate composition may have an aflatoxin mycotoxin level of about 20 ppb, about 15 ppb, about 10 ppb, about 5 ppb, about 1 ppb, about 0.5 ppb, about 0.1 ppb, about 0.05 ppb, 0 ppb, or any value or range between any two of these values (including endpoints). In particular embodiments, the portions of the deseeded coffee cherry and/or the particulate composition may have a fumonisin mycotoxin level of, per kilogram of body weight of a consumer, about 2 μg, about 1 μg, about 0.5 μg, about 0.1 μg, about 0.05 μg, about 0 μg, or any value or range between any two of these values (including endpoints). In particular embodiments, the portions of the deseeded coffee cherry and/or the particulate composition may have an ochratoxin mycotoxin level of about 10 ppb, about 5 ppb, about 1 ppb, about 0.5 ppb, about 0.1 ppb, about 0.05 ppb, 0 ppb, or any value or range between any two of these values (including endpoints). In particular embodiments, the portions of the deseeded coffee cherry and/or the particulate composition may have a vomitoxin mycotoxin level of about 1 ppm, about 0.5 ppm, about 0.1 ppm, about 0.05 ppm, about 0.01 ppm, or any value or range between any two of these values (including endpoints).

In various embodiments, the particulate composition may have a peak viscosity as measured by heating a paste at 90° C. in a Rapid Visco Analyzer. The paste may be formed from the particulate composition prepared in a slurry containing 5.5% particulate composition by dry weight. Alternatively, peak viscosity can be measured with the product at ambient room temperature in dry form without forming a slurry. The peak viscosity may be about 30 rapid visco units to about 3000 rapid visco units or about 200 rapid visco units to about 500 rapid visco units, including about 30 rapid visco units, about 50 rapid visco units, about 100 rapid visco units, about 200 rapid visco units, about 500 rapid visco units, about 1000 rapid visco units, about 2000 rapid visco units, about 3000 rapid visco units, or any value or range between any two of these values (including endpoints).

In various embodiments, the particulate composition may have a dry matter content in order to have a minimal amount of fluid in the particulate composition. The amount of fluid may generally include the total amount of water, inclusive of any amount of water that is present in the various portions of the particulate composition. In some embodiments, the dry matter content of the particulate composition may be about 80% by weight to about 100% by weight of the particulate composition, including about 80% by weight of the particulate composition, about 85% by weight of the particulate composition, about 88% by weight of the particulate composition, about 90% by weight of the particulate composition, about 95% by weight of the particulate composition, about 98% by weight of the particulate composition, about 100% by weight of the particulate composition, or any value or range between any two of these values (including endpoints).

In various embodiments, the particulate composition may absorb water. The amount of water absorbed by the particulate composition may be measured, for example, by placing a measured amount by weight of dry particulate composition in a container with a measured amount of water, and then incubating and stirring the mixture. Excess water is drained from the mixture and the moist precipitate is weighed. A water absorption index (WAI) can be calculated with the following equation:

$$WAI = \frac{mass of moist precipitate}{mass of dry particulate composition}$$

In some embodiments, the particulate composition may have a water absorption index of about 1 to about 20, including about 1, about 2, about 5, about 10, about 15, about 20, or any value or range between any two of these values (including endpoints).

In various embodiments, a food product may include the particulate composition as a first ingredient and at least one of a fat, a flour composition, a dairy product, a flavoring agent, a leavening agent, an enzyme, a modified starch, a gum, a reducing sugar, a sweetener, or a salt as a second ingredient, as described in greater detail herein. In some embodiments, the food product may further include at least one fluid. The fluid may be present in the food product in an amount of about 3% by weight to about 80% by weight of the food product or about 20% by weight to about 70% by weight, including about 3% by weight, about 5% by weight, about 10% by weight, about 15% by weight, about 20% by weight, about 25% by weight, about 30% by weight, about 35% by weight, about 40% by weight, about 45% by weight, about 50% by weight, about 55% by weight, about 60% by weight, about 65% by weight, about 70% by weight, about 75% by weight, about 80% by weight, or any value or range between any two of these values (including endpoints).

In various embodiments, a solid composition may include the particulate composition, including at least one portion of the dried coffee cherry. In some embodiments, the solid composition may be used in forming a food product, as described in greater detail herein. In some embodiments, the at least one portion of the dried coffee cherry may have an average particle size of about 0.1 μm to about 300 μm or about 0.1 μm to about 200 μm, including about 0.1 μm, about 1 μm, about 10 μm, about 40 μm, about 50 μm, about 100 μm, about 120 μm, about 200 μm, about 300 μm, or any value or range between any two of these values (including endpoints). In some embodiments, the solid composition may have a dry matter content of about 80% by weight to about 100% by weight, including about 80% by weight, about 85% by weight, about 90% by weight, about 95% by weight, about 100% by weight, or any value or range between any two of these values (including endpoints). In some embodiments, the solid composition may have a water absorption index of about 1 to about 20, including about 1, about 2, about 5, about 10, about 15, about 20, or any value or range between any two of these values (including endpoints). In some embodiments, the particulate composition may be present in the solid composition in an amount of about 1% to about 50% by weight of the solid composition, about 2% by weight to about 25% by weight, or about 20% by weight to about 35% by weight, including about 1% by weight, about 2% by weight, about 5% by weight, about 10% by weight, about 20% by weight, about 25% by weight, about 35% by weight, about 50% by weight, or any value or range between any two of these values (including endpoints). The solid composition may further include any number of additional ingredients as described in greater detail herein, including an oil, a fat, butter, margarine, shortening, lard, a flour composition, a dairy product, a flavoring agent, a leavening agent, an enzyme, a starch, a gum, a reducing sugar, a sweetener, a salt, and the like. In some embodiments, the solid composition may be substantially gluten-free, as described in greater detail herein.

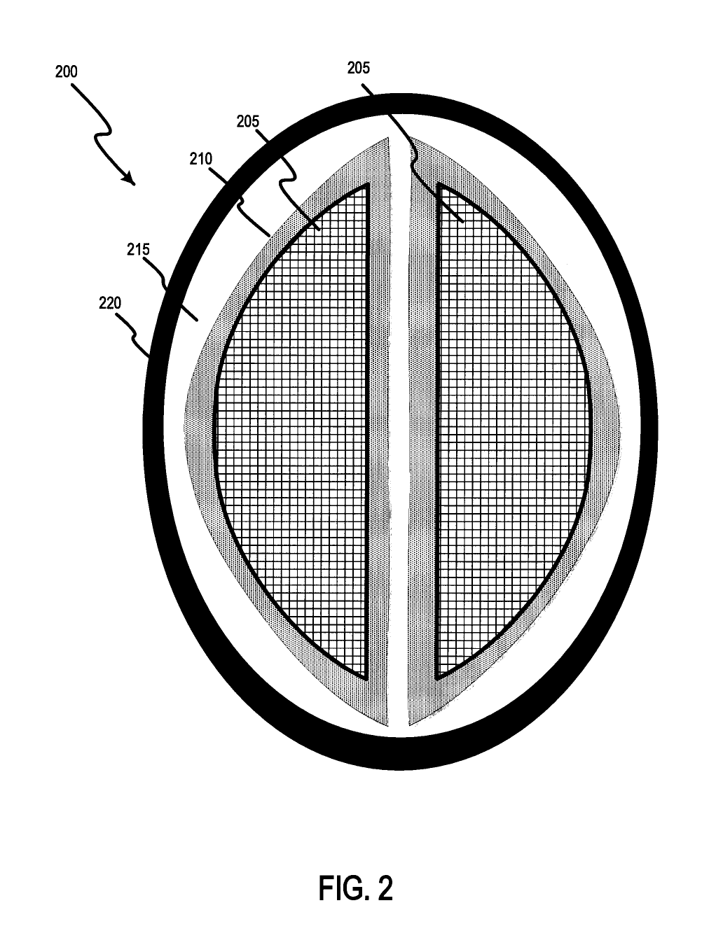

FIG. 2 depicts a second cross sectional view of a coffee cherry. As shown in FIG. 2, the coffee cherry 200 may include seeds 205 surrounded by a hull 210, a mucilage 215 and a pulp 220. The hull 210 may generally include the endocarp of the coffee cherry 200. The mucilage 215 may generally include the inner mesocarp of the coffee cherry 200. The pulp 220 may generally include at least a portion of the exocarp and the outer mesocarp of the coffee cherry 200.

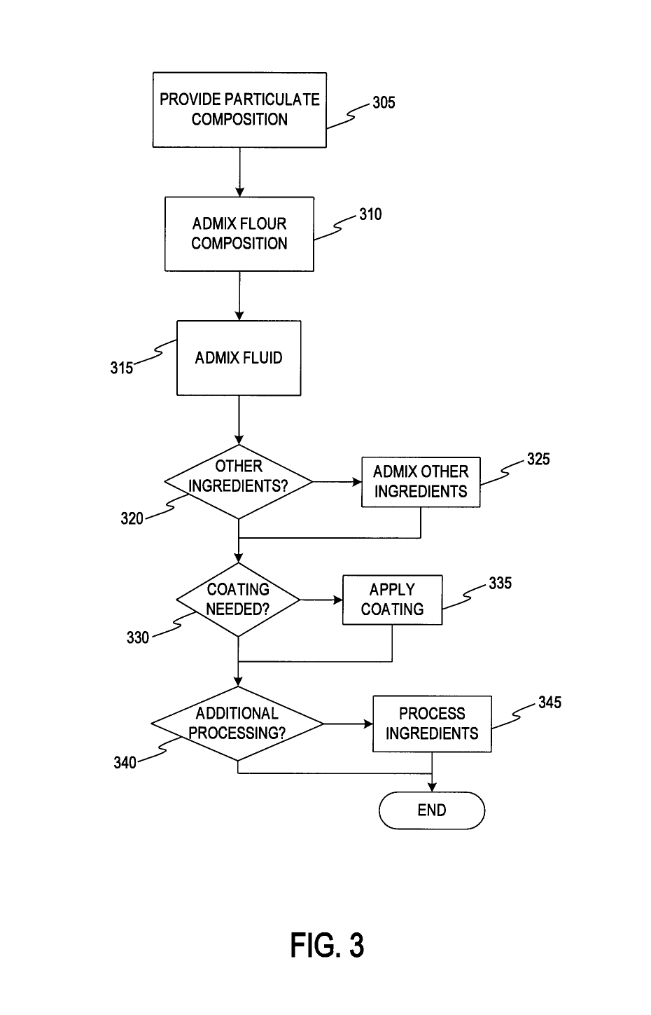

FIG. 3 depicts a flow diagram of a method of forming a food product according to an embodiment. The method described in reference to FIG. 3 may generally be used in whole or in part to form an edible food product. In some embodiments, a particulate composition may be provided 305. The particulate composition may generally include one or more portions of a dried and deseeded coffee cherry, as described in greater detail herein. The amount of particulate composition to be provided 305 may be based upon an amount necessary to obtain a desired food product, a desired taste, a desired texture, a desired consistency, and/or the like. In some embodiments, the particulate composition may be present in the food product in an amount of about 3% to about 80% by weight of the food product. In particular embodiments, the particulate composition may be present in the food product in an amount of about 3% by weight, about 5% by weight, about 10% by weight, about 15% by weight, about 20% by weight, about 25% by weight, about 35% by weight, about 40% by weight, about 50% by weight, about 75% by weight, about 80% by weight, or any value or range between any two of these values (including endpoints).

In various embodiments, a flour composition may be admixed 310 with the particulate composition to provide a dry composition. Admixing 310 the particulate composition and the flour composition can be completed by any method of combining, including, but not limited to, hand mixing, mixing with an electric handheld mixer, mixing with a stand mixer, mixing with a commercial mixing device, and/or the like. In some embodiments, the admixing 310 may be completed for a particular period of time, according to a particular method, and/or at a particular speed such that the dry composition is sufficiently blended. The dry composition may be sufficiently blended if a random sample of the dry composition contains a ratio of an amount by weight of the particulate composition to an amount by weight of the flour composition that corresponds to a desired ratio according to a particular recipe. For example, the ratio of the amount by weight of the particulate composition to the amount by weight of the flour composition may be about 1:1, about 2:1, about 3:1, about 5:1, about 10:1, about 20:1, about 1:2, about 1:3, about 1:5, about 1:10, about 1:20, or any value or range between any two of these values.

In some embodiments, the flour composition may be any type of flour composition now known or later developed, particularly flour compositions suitable for consumption purposes. The flour composition may be made from cereal grains, seeds, beans nuts, roots, and/or the like. Specific examples of flour compositions may include tapioca flour, rice flour, oat flour, wheat flour, buckwheat flour, barley flour, rye flour, corn flour, bean flour, peanut flour, almond flour, chestnut flour, acorn flour, amaranth flour, hemp flour, sorghum flour, sweet potato flour, chickpea flour, quinoa flour, taro flour, arrowroot flour, coconut flour, potato flour, dehydrated potato products (for example, dehydrated potato flakes, potato granules, potato flanules, mashed potato materials, and dried potato products), and the like, as well as mixtures thereof. In some embodiments, the flour composition, and by extension, the dry composition, may be substantially gluten-free, thereby containing a gluten content that is less than or equal to about 20 ppm, including about 20 ppm, about 15 ppm, about 10 ppm, about 5 ppm, about 1 ppm, about 0.5 ppm, about 0.1 ppm, about 0.05 ppm, 0 ppm or any value or range between any two of these values (including endpoints), as described in greater detail herein.

In various embodiments, at least one fluid may be admixed 315 with the dry composition to form a dough. In some embodiments, the fluid may be used to disperse at least one of the other ingredients described herein. In some embodiments, the fluid may be used to dissolve at least one of the other ingredients described herein. In some embodiments, the amount of fluid present in the dough may be about 20% by weight to about 70% by weight of the dough, including about 20% by weight, about 25% by weight, about 30% by weight, about 35% by weight, about 40% by weight, about 45% by weight, about 50% by weight, about 55% by weight, about 60% by weight, about 65% by weight, about 70% by weight, or any value or range between any two of these values (including endpoints). Correspondingly, the amount of dry composition present in the dough may be about 30% by weight to about 80% by weight of the food mixture, including about 30% by weight, about 35% by weight, about 40% by weight, about 45% by weight, about 50% by weight, about 55% by weight, about 60% by weight, about 65% by weight, about 70% by weight, about 75% by weight, about 80% by weight, or any value or range between any two of these values (including endpoints). The type of fluid is not limited by this disclosure, and may include any fluid, liquid, semiliquid, slurry, and/or the like, including fluid versions of other ingredients described herein, water, juice, broth, maltodextrin solids, corn syrup solids, and/or the like. Other fluids include dairy milk, non-dairy milk, nut milks, rice milks, tea, coffee, kava, and other dried food extract fluids, and so on.

In various embodiments, a determination 320 may be made as to whether additional ingredients should be added to the dough and/or the dry composition. The determination 320 may generally be based upon, for example, a desired type of food product, a desired flavor, a desired texture, a desired consistency, whether additional nutrients are needed, and/or the like.

If the determination 320 is that additional ingredients should be added, the additional ingredients may be admixed 325 with the dough and/or the dry composition. In some embodiments, the additional ingredients may be admixed 325 so that the additional ingredients comprise about 1% by weight to about 15% by weight of the dough, including about 1% by weight, about 5% by weight, about 10% by weight, about 15% by weight, or any value or range between any two of these values. Examples of additional ingredients are not limited by this disclosure, and may include, for example, one or more of an oil, a fat, a dairy product, a flavoring agent, a leavening agent, an enzyme, a starch, a modified starch, a gum, a reducing sugar, a sweetener, a salt, and/or the like.

In some embodiments, at least one oil and/or at least one fat may be added to provide a desired texture and/or consistency, to add flavor, to provide a moist food product, and/or to act as a binder for the remaining ingredients in the food product and/or the solid composition. Specific examples of fats may include butter, margarine, shortening, lard, and/or the like. Specific examples of oils may include vegetable oil, castor oil, egg oil, rapeseed oil, soybean oil, corn oil, coconut oil, palm oil, safflower oil, sunflower seed oil, cottonseed oil, sesame oil, olive oil, camellia oil, rice oil, and/or the like.

In some embodiments, at least one dairy product may be added to provide a desired texture and/or consistency, to add flavor, to provide a moist food product, and/or to act as a binder for the remaining ingredients in the food product and/or the solid composition. Specific examples of dairy products may include butter, cheese, milk, buttermilk, condensed milk, powdered milk, whey, yogurt, cream, whipping cream, sour cream, and/or the like.

In various embodiments, at least one flavoring agent may generally provide the food product and/or the solid composition with a preferred or a desired flavor, to lessen the impact of undesirable flavors caused by other ingredients, and/or the like. In some embodiments, the flavoring agent may be used as a topping, a sandwich filling, and/or the like. The flavoring agent is not limited by this disclosure, and may generally be any ingredient used to provide a flavor to the food product and/or the solid composition. In some embodiments, the flavoring agent may include other ingredients described herein. In some embodiments, the flavoring agent may provide a savory flavor. Illustrative examples of flavoring agents may include, but are not limited to, barbecue, bacon, spices, herbs, dry vegetables such as onion, garlic, or tomato, dairy, peanut butter, nuts, seeds, vanilla, chocolate, and/or the like.

In some embodiments, at least one leavening agent may be added to provide a desired texture and/or consistency, to lighten the food product and/or the solid composition, and/or to soften the food product and/or the solid composition. Specific examples of leavening agents may include a carbon dioxide (CO₂) carrier agent such as baking soda, tartaric acid, citric acid, acid sodium, potassium salts of tartaric acid, calcium salts of tartaric acid, potassium salts of citric acid, calcium salts of citric acid, orthophosphoric acid, pyrophosphoric acid, calcium lactate, calcium sulfate, and/or the like.

At least one enzyme may generally be used to aid in processing various starches used in the food product and/or the solid composition. In some embodiments, the enzyme may improve the quality of the food product and/or the solid composition such that it conforms to a desired taste and/or consistency. Specific examples of enzymes may include papain, bromelain, ficin, trypsin, chymotrypsin, and/or the like.

As described herein, at least one starch may be used as a thickening and/or a stabilizing agent. In some embodiments, a degree of crispness/crunchiness, mouthmelt (a product dissolving in the mouth), and flavor release may be controlled by the addition of a starch. Specific examples of starches may include starch hydrolyzate, hydroxyalkylated starch, starch ester, cross-linked starch, starch acetate, starch octenyl succinate, and/or the like.

A modified starch, as used herein, may be a starch prepared by treating starch or starch granules, thereby causing the starch to be partially modified in its molecular structure. The modified starch may be used in the food product and/or the solid composition as a thickening agent, a stabilizer, or an emulsifier. In some embodiments, a degree of crispness/crunchiness, mouthmelt, and flavor release may be controlled by the addition of a modified starch. In addition, the percent of amylose and/or amylopectin and the degree of gelatinization may help control organoleptic properties of the food product and/or the solid composition by affecting the binding and release of water and matrix discontinuity. In some embodiments, the modified starch may have a water absorption index of about 0.4 to about 8.0, including about 0.4, about 0.5, about 1.0, about 2.0, about 3.0, about 4.0, about 5.0, about 6.0, about 7.0, about 8.0, or any value or range between any two of these values (including endpoints). Illustrative examples of modified starches may include starch derivatives, hydrolysis products of starch, and derivatives of hydrolysis products of starch. Specific examples of the starch derivatives may include starch acetate, carboxymethyl starch, hydroxyalkylated starch, starch phosphate, cationic starch, alkyl starch ether, and the like. The hydrolysis products of starch are those obtained by severing molecular chains of starch by the use of an enzyme, an acid, an alkali, and/or heat to reduce its molecular weight, with specific examples including thinly-made starch paste, white dextrin, British gum, soluble starch and the like. The derivatives of hydrolysis products of starch include those obtained by hydrolyzing the above-described derivatives of starch, and those obtained by converting the above-described hydrolysis products of starch into their derivatives through various treatments such as hydroxyalkyletherification, carboxymethylation, acetylation, and the like. Particular types of modified starches that may be used in accordance with the present disclosure include hydroxyalkylated (especially hydroxyethylated or hydroxypropylated) starches, their hydrolysis products, and those obtained by hydroxyalkyl (especially hydroxyethyl or hydroxypropyl) etherifying hydrolysis products of starch.

At least one reducing sugar may be used to provide desired texture, consistency, and color properties to the food product and/or the solid composition. The reducing sugar may generally be any sugar that has an aldehyde group or any sugar that is capable of forming an aldehyde group via isomerism. Specific examples of reducing sugars may include maltose, lactose, dextrose and/or the like.

In some embodiments, at least one gum may be added to provide a desired texture and/or consistency, to thicken the food product and/or the solid composition, and/or to stabilize the food product and/or the solid composition. The gum may be present in the dry composition in an amount that is less than or equal to about 10% by weight, about 1% by weight to 8% by weight, or about 2% by weight to 4% by weight, including about 0.1% by weight, about 0.5% by weight, about 1% by weight, about 2% by weight, about 3% by weight, about 4% by weight, about 5% by weight, about 6% by weight, about 7% by weight, about 8% by weight, about 9% by weight, about 10% by weight, or any value or range between any two of these values (including endpoints). Specific examples of gums may include guar gum, xanthan gum, gellan gum, carrageenan gum, gum Arabic, gum tragacanth, pectic acid, and/or the like. Gum Arabic is a natural food additive obtained from certain varieties of acacia. It is generally tasteless and odorless, and may be used in commercial food processing to thicken, emulsify, and/or stabilize foods. Guar gum is a gummy substance obtained from plants of the legume genera. Guar gum may also be used as a thickener and/or a stabilizer in commercial food processing. Xanthan gum is produced by fermentation of corn sugar, and may be used as a thickener, an emulsifier, and/or a stabilizer of foods.

At least one sweetener may be in a solid, a semi-solid, or a liquid form, and may further be a caloric or a noncaloric sweetener. Specific examples of caloric sweeteners may include glucose, dextrose, fructose, lactose, sucrose, isomaltose, maltodextrin, corn syrup and the like, as well as mixtures thereof. Specific examples of noncaloric sweeteners may include acesulfame potassium, aspartame, neotame, saccharin, sucralose, and the like, as well as mixtures thereof.

At least one salt may be used to provide flavor, consistency, color, and/or texture of the food product and/or the solid composition. The salt may also be used as a preservative for some food products. The salt may generally be any acidic and/or basic salt formed with inorganic and/or organic acids and bases. In addition, when a compound contains both a basic moiety and an acidic moiety, an inner salt may be formed and are included within the term “salt(s)” as used herein. In particular embodiments, physiologically, pharmaceutically, nutritionally, and nutraceutically acceptable salts may be used.

In some embodiments, the food product and/or the solid composition may include at least one emulsifier. The emulsifier may aid in the processability of the food product and/or the solid composition. In some embodiments, the emulsifier may be dissolved in a fat or in a polyol fatty acid polyester. An illustrative polyol fatty acid polyester is Olean™ (Proctor & Gamble, Cincinnati Ohio). Illustrative emulsifiers may include, for example, lecithin, monoglycerides, diglycerides, diacetyl tartaric acid esters, propylene glycol monoesters, propylene glycol diesters, polyglycerol esters and/or the like. Polyglycerol emulsifiers, such as monoesters of hexapolyglycerols, may also be used.

In various embodiments, the ingredients described herein may be added to the food product and/or the solid composition in the form of a pre-blended material. The pre-blended material is not limited by this disclosure and may include any type of pre-blended material, such as pre-packaged items and the like. For example, the various ingredients may be combined to the particulate composition in the form of a boxed cake mix, a boxed brownie mix, a boxed bread mix, a boxed pasta flour, and/or the like.

In various embodiments, a determination 330 may be made as to whether a coating is necessary for the dough. If a coating is necessary, the coating may be applied 335. Examples of coatings are not limited by this disclosure, and may be any type of coating, particularly coatings that are used for food products. Specific examples of coatings may include a batter coating, a breaded coating, a candy coating, a drizzle coating, and/or the like.

In various embodiments, a determination 340 may be made as to whether additional processing of the dough and/or the various other ingredients is necessary. If additional processing is necessary, the dough and/or the various other ingredients may be processed 345. Examples of additional processing may include, for example, sheeting, extruding, cutting, filing, folding, baking, boiling, frying, freezing, steaming, packaging and/or the like. The additional processing may generally be completed to cook the ingredients to obtain the food product, to convert the ingredients into the food product, to prepare the ingredients for shipping and delivery, and/or the like. In some embodiments, the dough may be processed 345 with an extruder to mix the dough and form sheets or shaped pieces.

In various embodiments, the dough may be processed 345 by cutting into various pasta shapes and sizes. Illustrative shapes may include elbow macaroni, shells, bowtie pasta, corkscrew pasta, linguine, spaghetti, gnocchi, and/or the like. The dough may also be cut for filled pasta, such as, for example, tortellini, ravioli, pierogies, or wontons. The filled pasta may include one or more of a meat (such as beef, chicken, turkey, or pork), a vegetable (such as cabbage/sauerkraut, or spinach), a fruit, a cheese (such as farmer's cheese, cottage cheese, or ricotta cheese), a mushroom, and a potato. In some embodiments, the dough may be shaped by flattening it on a sheet and cutting it into long strips. In some embodiments, the dough may be shaped with a pasta making apparatus, such as a pasta maker attachment that is available for common stand mixers. In some embodiments, the pasta may be dry pasta that is marketed and sold in a box, a refrigerated pasta, a canned pasta, or a pasta in a sauce, a soup, or a salad.

### EXAMPLES

### Example 1

### Preparation of Rye Bread

A boxed rye bread mix was altered to include a particulate composition as described herein. The rye bread mix, before the addition of the particulate composition, weighed 425 grams and contained the following ingredients: unbleached and enriched flour (wheat flour, malted barley flour, niacin, iron, thiamine, riboflavin, and folic acid), stone ground whole grain rye flour, stone ground whole grain wheat flour, sugar, wheat gluten, soy flour, caraway seeds, salt, and vitamin C. Yeast was provided in a separate package, but was factored in towards the total weight of the mix. Upon addition of 75 grams of the particulate composition, the total weight was 500 grams, with 15% of the total weight being particulate composition.

The boxed rye bread mix and the particulate composition were made according to the original recipe on the box, which required the entire package of bread mix and 2 tablespoons (Tbsp.) of butter. The bread mix, the particulate composition, and the butter were hand mixed together in a bowl with a fork and set aside. In a separate bowl, the yeast and 1 cup of warm water were combined and allowed to stand for 5 minutes. The bread mix, the particulate composition, and the butter were slowly poured into the yeast and water mix, and the dough was kneaded until it was smooth. The dough was placed in a bowl and covered with a damp cloth for 1.5 hours to allow the dough to rise. The dough was again kneaded, placed in a bread pan, and allowed to rise for an additional 30 minutes. The dough was then baked in a preheated 350° F. (177° C.) oven for about 30 minutes.

The resulting bread had a taste that was citrus-cherry-caramel flavored with a bit of roasted cocoa. The texture proved to be consistent with a texture that is typical for rye bread.

### Example 2

### Preparation of Rye Crostini

The same boxed mix as used in Example 1 was used to make crostini. However, an additional 100 grams of particulate composition was added, bringing the total to 175 grams of particulate composition, 425 grams of the bread mix, and 600 grams total. Thus, the particulate composition was about 29% by weight of the total composition.

The ingredients were made according to the recipe described in Example 1 to obtain the completed crostini product. The resulting crostini were brittle, with a crumble and a mouth feel that was very similar to that of a shortbread cookie. The taste was consistent with the results of Example 1.

### Example 3

### Preparation of Gnocchi

A typical potato gnocchi recipe was altered to include a particulate composition as described in greater detail herein. Other ingredients included potatoes, eggs, flour, and salt. The particulate composition was included in an amount of about 20% by weight of all of the ingredients in the gnocchi recipe. The resultant gnocchi had a pleasing tooth feel and mouth feel, with a pleasing snap and bite when chewed. The color of the gnocchi was darker than typical gnocchi, which are normally off white to yellowish in color. The color complemented items like mushrooms, poached eggs, truffles, nettles, and leeks, which were used for various garnishes and sauces.

### Example 4

### Preparation of Linguine Pasta

Linguine pasta was made with flour, eggs, and the particulate composition described herein. The particulate composition made up 50% of the total weight of the ingredients. The resulting dough was kneaded until smooth, rolled into flat sheets, and cut into thin linguine strips using a commercially available pasta maker. The resulting linguine was delicate with some slight elasticity, but held in all cooking conditions and did not fall apart. The resulting linguine was a dark coffee bean brown color and had a generally pleasant taste.

### Example 5

### Preparation of Ravioli

Ravioli were prepared according to the recipe described in Example 4. The dough was kneaded until smooth, rolled into flat sheets, and cut into squares for ravioli. The ravioli were then stuffed with Dungeness crab and herbs and cooked. Once cooked, the ravioli were topped with a spot prawn roe butter. The resulting ravioli were a dark coffee bean brown with a taste that was nicely complemented by the crab and the butter.

### Example 6

### Preparation of Fish Topping

A piece of uncooked monkfish was dusted with the particulate composition, as described herein. The particulate composition adhered well to the raw, moist fish and did not clump into large pieces. When the fish was sautéed, the particulate composition crisped very well, similar to the effects typically observed with all-purpose flour or rice flour. Thus, the particulate composition provided a pleasing crust on the cooked monkfish, upon which it imparted a very unique caramel and citrusy flavor that complemented the monkfish flavor very well.

The food products prepared according to the foregoing examples are generally food products having a high antioxidant content. In addition, edible food products that are visually and tastefully pleasing were obtained from deseeded coffee cherries that would otherwise be considered waste products.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A food product comprising:
a first ingredient comprising one or more portions of a dried coffee cherry, wherein the one or more portions of the dried coffee cherry comprise at least one of a pulp, a mucilage, and a hull, and do not comprise a coffee bean; and
a second ingredient comprising at least one of a fat, a flour composition, a dairy product, a flavoring agent, a leavening agent, an enzyme, a modified starch, a gum, a reducing sugar, a sweetener, or a salt.

2. The food product of claim 1, wherein the one or more portions of the dried coffee cherry consist of at least one of a hull, a mucilage, a silverskin, a parchment coat, a pectin layer, a pulp, and an outer skin.

3. (canceled)

4. The food product of claim 1, further comprising at least one fluid.

5. The food product of claim 1, wherein the first ingredient is present in the food product in an amount of about 3% by weight to about 80% by weight of the food product.

6. (canceled)

7. The food product of claim 1, wherein the first ingredient has at least one of:
an average particle size of about 0.1 μm to about 3000 μm;
a dry matter content of about 80% by weight to about 100% by weight;
a peak viscosity of the first ingredient is about 30 rapid visco units to about 3000 rapid visco units; and
a water absorption index of about 1 to about 20.

8.-12. (canceled)

13. The food product of claim 1, wherein the second ingredient further comprises one or more of oil, butter, margarine, shortening, lard, tapioca flour, rice flour, oat flour, wheat flour, buckwheat flour, barley flour, rye flour, corn flour, bean flour, peanut flour, almond flour, chestnut flour, acorn flour, amaranth flour, hemp flour, sorghum flour, sweet potato flour, chickpea flour, quinoa flour, taro flour, arrowroot flour, coconut flour, potato flour, starch hydrolyzate, hydroxyalkylated starch, starch ester, cross-linked starch, starch acetate, starch octenyl succinate, guar gum, xanthan gum, gellan gum, carrageenan gum, gum Arabic, gum tragacanth, pectic acid, maltose, lactose, dextrose, glucose, fructose, lactose, sucrose, isomaltose, maltodextrin, and corn syrup.

14. The food product of claim 1, wherein the second ingredient further comprises a flour composition made from one or more of cereal grains, seeds, nuts, beans, and roots.

15.-19. (canceled)

20. The food product of claim 1, wherein the food product is one or more of a baked good, a pre-fabricated good, a fried good, a chilled good, a nutritional supplement, a steamed good, a cracker, a brownie, a cake, a cake-like product, a pastry, a snack, an energy bar, a batter coating, a cookie, a bread, a pasta, a noodle, a filled food product, a flatbread, a dumpling, a steamed bun, a breaded coating, and a cereal.

21. (canceled)

22. The food product of claim 1, wherein the first ingredient has mycotoxin levels of less than about 20 parts per billion for total aflatoxins, less than about 2 parts per million for total fumonisins, less than about 10 parts per billion for total ochratoxins, and less than about 5 parts per million for total vomitoxins.

23.-26. (canceled)

27. A substantially gluten-free food product comprising:
a first ingredient comprising one or more portions of a dried coffee cherry, wherein the one or more portions of the dried coffee cherry comprise at least one of a pulp, a mucilage, and a hull, and do not comprise a coffee bean; and
a second ingredient comprising at least one of a fat, a flour composition, a dairy product, a flavoring agent, a leavening agent, an enzyme, a modified starch, a gum, a reducing sugar, a sweetener, or a salt,
wherein the food product has a gluten content of less than about 20 parts per million.

28. The food product of claim 27, wherein the one or more portions of the dried coffee cherry consist of at least one of a pulp, a mucilage, and a hull.

29. (canceled)

30. The food product of claim 27, further comprising at least one fluid.

31. The food product of claim 30, wherein the first ingredient is present in the food product in an amount of about 30% by weight to about 80% by weight of the food product.

32. The food product of claim 30, wherein the fluid is present in the food product in an amount of about 20% by weight to about 70% by weight of the food product.

33. The food product of claim 27, wherein the first ingredient has:
an average particle size of about 0.1 μm to about 3000 μm;
a dry matter content of about 80% by weight to about 100% by weight;
a peak viscosity of the first ingredient is about 30 rapid visco units to about 3000 rapid visco units; and
a water absorption index of about 1 to about 20.

34.-38. (canceled)

39. The food product of claim 27, wherein the second ingredient further comprises one or more of oil, butter, margarine, shortening, lard, tapioca flour, rice flour, oat flour, wheat flour, buckwheat flour, barley flour, rye flour, corn flour, bean flour, peanut flour, almond flour, chestnut flour, acorn flour, amaranth flour, hemp flour, sorghum flour, sweet potato flour, chickpea flour, quinoa flour, taro flour, arrowroot flour, coconut flour, potato flour, starch hydrolyzate, hydroxyalkylated starch, starch ester, cross-linked starch, starch acetate, starch octenyl succinate, guar gum, xanthan gum, gellan gum, carrageenan gum, gum Arabic, gum tragacanth, pectic acid, maltose, lactose, dextrose, glucose, fructose, lactose, sucrose, isomaltose, maltodextrin, and corn syrup.

40. The food product of claim 27, wherein the second ingredient further comprises a flour composition made from one or more of cereal grains, seeds, nuts, beans, and roots.

41.-45. (canceled)

46. The food product of claim 27, wherein the food product is one or more of a baked good, a pre-fabricated good, a fried good, a chilled good, a nutritional supplement, a steamed good, a cracker, a brownie, a cake, a cake-like product, a pastry, a snack, an energy bar, a batter coating, a cookie, a bread, a pasta, a noodle, a filled food product, a flatbread, a dumpling, a steamed bun, a breaded coating, and a cereal.

47. (canceled)

48. The food product of claim 27, wherein the first ingredient has mycotoxin levels of less than about 20 parts per billion for total aflatoxins, less than about 2 parts per million for total fumonisins, less than about 10 parts per billion for total ochratoxins, and less than about 5 parts per million for total vomitoxins.

49.-52. (canceled)

53. A solid composition comprising:
at least one portion of a dried coffee cherry, wherein the portion of the dried coffee cherry is a deseeded coffee cherry comprising at least one of a pulp, a mucilage, and a hull, and wherein the portion of the dried coffee cherry has an average particle size of about 0.1 μm to about 3000 μm.

54. The solid composition of claim 53, wherein the portion of the dried coffee cherry consists of at least one of a pulp, a mucilage, and a hull.

55. (canceled)

56. The solid composition of claim 53, wherein the portion of the dried coffee cherry has an average particle size of about 0.1 μm to about 200 μm.

57. (canceled)

58. The solid composition of claim 53, wherein the solid composition has at least one of:
a peak viscosity of about 30 rapid visco units to about 3000 rapid visco units;
a dry matter content of about 80% by weight to about 100% by weight of the solid composition; and
a water absorption index of about 1 to about 20.

59.-60. (canceled)

61. The solid composition of claim 53, wherein the portion of the dried coffee cherry is present in the solid composition in an amount of about 1% to about 50% by weight of the solid composition.

62.-75. (canceled)

76. The solid composition of claim 53, wherein the solid composition has a gluten content of about 20 parts per million.

77. The solid composition of claim 53, wherein the portion of the dried coffee cherry has mycotoxin levels of less than about 20 parts per billion for total aflatoxins, less than about 2 parts per million for total fumonisins, less than about 10 parts per billion for total ochratoxins, and less than about 5 parts per million for total vomitoxins.

78.-81. (canceled)

82. A method of forming a food product, the method comprising:
providing a particulate composition comprising at least one portion of a dried coffee cherry, wherein the dried coffee cherry comprises a deseeded coffee cherry;
admixing a flour composition with the particulate composition to provide a dry composition; and
admixing at least one fluid to the dry composition to form a dough.

83.-84. (canceled)

85. The method of claim 82, further comprising at least one of:
processing the dough to obtain a dough product, wherein the processing comprises one or more of sheeting, extruding, cutting, filing, and folding;
baking the dough;
frying the dough;
freezing the dough;
steaming the dough; and
coating a food item with the dough to form a coated food.

86.-90. (canceled)

91. The method of claim 82, further comprising at least one of:
admixing the dry composition with one or more of at least one oil and at least one fat;
admixing at least one dairy product with the dry composition;
admixing at least one flavoring agent with the dry composition;
admixing at least one leavening agent with the dry composition;
admixing at least one enzyme with the dry composition;
admixing at least one sweetener with the dry composition, wherein the sweetener comprises glucose, fructose, lactose, sucrose, isomaltose, maltodextrin, or corn syrup;
admixing at least one modified starch with the dry composition, wherein the modified starch comprises starch hydrolyzate, hydroxyalkylated starch, starch ester, cross-linked starch, starch acetate, or starch octenyl succinate;
admixing at least one gum with the dry composition, wherein the gum comprises guar gum, xanthan gum, gellan gum, carrageenan gum, gum Arabic, gum tragacanth, or pectic acid; and
admixing at least one reducing sugar with the dry composition, wherein the reducing sugar comprises one or more of maltose, lactose, or dextrose.

92.-103. (canceled)
